(19) United States
(12) Patent Application Publication
(10) Pub. No.: US 2007/0106628 A1
(43) Pub. Date: May 10, 2007

(54) Dialogue strategies

(75) Inventors: Iqbal Adjali, Bedford (GB); Ogi Bataveljic, Bedford (GB); Marco De Boni, Bedford (GB); Malcolm Benjamin Dias, Bedford (GB); Robert Hurling, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/238,518

(22) Filed: Sep. 29, 2005

(51) Int. Cl. G06N 5/00; G06F 17/00

(52) U.S. Cl. 706/45

(57) ABSTRACT

A human-computer interface for automated adaptive persuasion dialogue and a method of operating such an interface. The method comprising presenting a user with a series of decision points, each requiring the user to select one of a plurality of possible decision options; presenting the user with at least one persuasion message corresponding to each of the possible decision options, each persuasion message being selected according to one of a plurality of different persuasion strategies and receiving the user selection of one of the possible decision options. The presenting and receiving steps are then repeated to obtain user selected decision options for decision points based on a plurality of persuasion strategies to determine a persuasion strategy that is optimised for the user, allowing subsequent persuasion messages to be delivered to the user based on the optimised persuasion strategy.

The present invention relates to automated dialogue systems, and in particular relates to methods and apparatus for facilitating adaptive persuasion dialogues.

Various forms of automated dialogue systems and interactive computing devices are known to exist in the prior art. For instance, auto-teller machines (ATMs) and informational kiosks have been commonly available for many years. However, the relatively recent emergence of mobile computing devices, such as laptops, personal digital assistants and smart mobile phones, has seen the development of new human-computer interfaces which attempt to adapt the dialogue in a way that is more suited and/or influential to the user of the device.

Such interfaces are able to provide a limited degree of human-computer interaction and can provide some measure of persuasive or influential effect on the behaviour or action of the user. However, a significant drawback of conventional dialogue interfaces is that they have no ‘intelligence’, in that they have no knowledge of which persuasive techniques, strategies or influences are most suited to the user of the interface, nor are they able to adapt the dialogue to incorporate such influences.

When humans interact with one another, they either consciously or sub-consciously attempt to engender a positive response, affirmation or feedback from the other individual, by using a variety of psychological and/or physiological persuasive influences, either knowingly or otherwise. Therefore, in order for an automated dialogue interface to emulate natural human interaction, the interface needs to have knowledge of what persuasive strategies and influences work best with the user of the interface, so as to be able to adapt the dialogue in a persuasive manner.

An object of the present invention is to provide a human-computer interface that can automatically adapt a persuasion dialogue between a user and the interface, based on one or more optimised persuasion strategies.

Another object of the present invention is to provide an automated persuasion dialogue interface that can optimise a persuasion strategy for a user of the interface by learning which strategy is most effective for influencing that user.

According to an aspect of the present invention there is provided a method of operating a human-computer interface, comprising:
(a) presenting a user with a series of decision points, each requiring the user to select one of a plurality of possible decision options;
(b) presenting the user with at least one persuasion message corresponding to each of the possible decision options, each persuasion message being selected according to one of a plurality of different persuasion strategies;
(c) receiving the user selection of one of the possible decision options;
(d) repeating steps (a) to (c) to obtain user selected decision options for decision points based on a plurality of persuasion strategies to determine a persuasion strategy that is optimised for the user;
(e) subsequently delivering persuasion messages to the user based on the optimised persuasion strategy.

According to another aspect of the present invention there is provided a human-computer interface for adaptive persuasion dialogue, comprising:
(a) means for presenting a user with a series of decision points, each requiring the user to select one of a plurality of possible decision options;
(b) means for presenting the user with at least one persuasion message corresponding to each of the possible decision options, each persuasion message being selected according to one of a plurality of different persuasion strategies;
(c) means for receiving the user selection of one of the possible decision options;
(d) means for determining a persuasion strategy that is optimised for the user by repeating the presenting and receiving steps in (a) to (c) to obtain user selected decision options for decision points based on a plurality of persuasion strategies; and
(e) means for subsequently delivering persuasion messages to the user based on the optimised persuasion strategy.

Embodiments of the present invention will now be described in detail by way of example and with reference to the accompanying drawing in which:

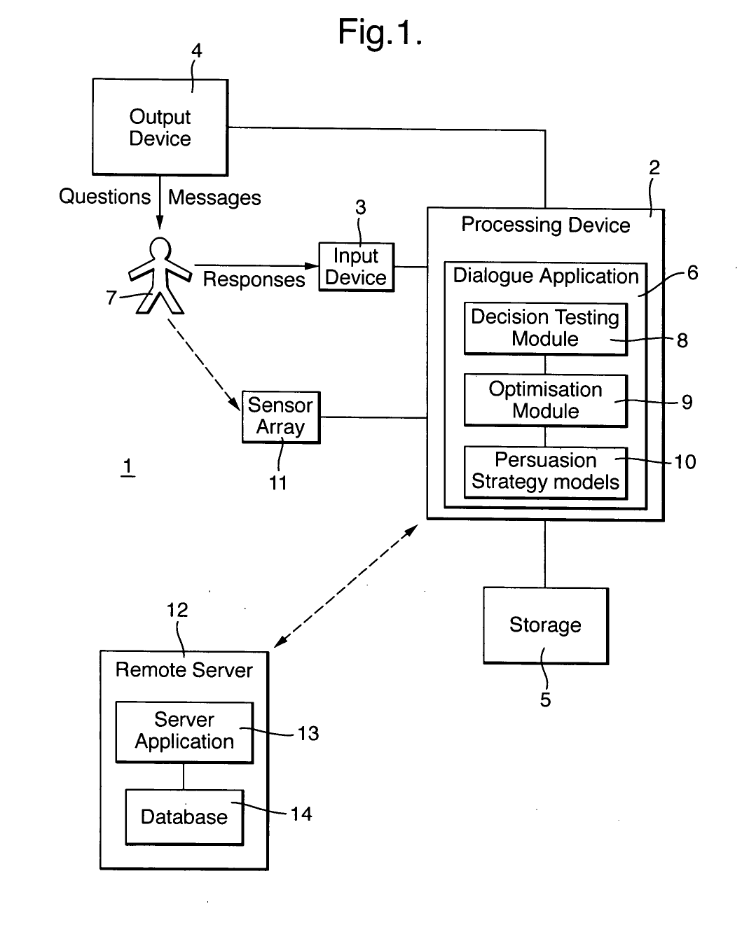

FIG. 1 is a schematic view of a particularly preferred arrangement of an automated human-computer persuasion dialogue interface according to the present invention.

With reference to FIG. 1 there is shown a particularly preferred arrangement of an automated human-computer persuasion dialogue interface 1 (hereinafter referred to as the “interface”) according to the present invention. The interface 1 comprises a processing device 2, an input device 3, an output device 4 and one or more storage devices 5 associated with the processing device 2.

The interface 1 of the present invention may be implemented on any suitable computing system or apparatus having a processing device 2 capable of executing the dialogue application 6 of the present invention (discussed below). Preferred computing apparatus include, but are not limited to, desktop personal computers (PCs), laptop computers, personal digital assistants (PDAs), smart mobile phones, ATM machines, informational kiosks and electronic shopping assistants etc., modified, as appropriate, in accordance with the prescription of the following arrangements.

It is to be appreciated however, that the present interface 1 may be implemented on, or form a part thereof, of any suitable portable or permanently sited computing apparatus that is capable of interacting with a user.

In most applications, the processing device 2 will correspond to one or more central processing units (CPUs) within the computing apparatus, and it is to be understood that the present interface may be implemented using any suitable processor or processor type.

Preferably, the dialogue application 6 may be implemented using any suitable programming language, e.g. C, C++, JavaScript etc. and is preferably platform/operating system independent, to thereby provide portability of the application to different computing apparatus. In desktop PC and laptop applications for instance, it is intended that the dialogue application 6 be installed by accessing a suitable software repository, either remotely via the internet, or directly by inserting a suitable media containing the repository (e.g. CD-Rom, DVD, Compact Flash, Secure Digital card etc.) into the computing apparatus.

In accordance with the present invention, the dialogue application 6 is operable to present to a user 7 as series of decision points, each point requiring the user 7 to select one of a plurality of possible decision options. The decision points are preferably simple questions or tasks having two or more possible answers or responses in the form of decision options. Preferably, each possible decision option has at least one corresponding persuasion message which is selected by the dialogue application 6 according to one of a plurality of different persuasion strategies (discussed below). The dialogue application 6 receives the user's selected decision options and determines an optimum persuasion strategy that appears to be the most appropriate for the user 7, based on the user's selected decision options. In this way, the dialogue application 6 is able to adapt a dialogue between the interface 1 and user 7, such that a more persuasive and influential content can be delivered to the user 7.

By ‘dialogue’ we mean an exchange of information or data between the interface 1 and user 7 either verbally, visually, textually or any combination thereof. In preferred arrangements, the dialogue comprises one or more ‘persuasion messages’, preferably corresponding to messages that have a content that is intended to have some form of persuasive effect or influence on a psychological and/or physiological behaviour or action of the user 7.

In preferred arrangements, the dialogue application 6 comprises a number of software modules including a decision testing module 8 and an optimisation module 9. The software modules preferably form part of the coding of the dialogue application 8 itself, or else may form separate modules or applets that are linked and invoked by the dialogue application 6 during execution.

The decision testing module 8 is preferably configured to present a series of decision points to the user 7 by way of the output device 4 associated with the processing device 2. The output device 4 may be any suitable device for presenting the user 7 with the series of decision points, and is preferably in the form of a display screen, such as a TFT, LCD or CRT etc. Alternatively, or additionally, the output device 4 may include a conventional speaker (or speaker jack) so as to provide an audible output to the user 7, such that the decision points may be presented verbally as well as visually (e.g. via text etc.).

The user 7 responds to the series of presented decision points by providing an input response corresponding to one of the plurality of possible decision options. In preferred arrangements, the user 7 responds by way of the input device 3, which is coupled to the decision testing module 8 by way of the dialogue application 6. The input device 3 is preferably some form of haptic interface, e.g. a keyboard, keypad, joystick, mouse, touch-sensitive pad or screen etc. However, it is to be appreciated that the input device 3 may be any suitable means that is capable of providing a distinct, recognisable signal to the decision testing module 8 corresponding to a respective decision option.

In some preferred arrangements, the input device 3 is a conventional microphone or audio transducer, allowing the user 7 to verbally select the decision options as he/she progresses through the series of decision points. Preferably, in these arrangements the dialogue application 6 includes a voice recognition algorithm to interpret the verbal responses from the user 7.

As well as presenting the user 7 with a series of decision points and possible decision options, the decision testing module 8 also preferably presents at least one persuasion message to the user 7 corresponding to each of the possible decision options. Each persuasion message is selected according to one of the different persuasion strategies that are preferably embodied in separate psychological and sociological models stored in a persuasion strategy model repository 10 associated with the dialogue application 6. Preferably, the model repository 10 is stored on a non-volatile storage device 5 associated with the processing device 2. During execution of the dialogue application 6, the strategy models can be accessed from the storage device 5 as and when required, or else can preferably be buffered into memory during run-time to increase speed of execution.

In accordance with the present invention, the purpose of the persuasion messages accompanying the decision options is to attempt to persuade or influence the user 7 to select a particular decision option over that of any other decision option, the idea being to determine which persuasion strategy is more, or most, effective with that particular user 7.

There are many psychological and sociological models that attempt to predict or explain the principles of persuasion and influence on the behaviour or actions of humans. However, one of the most reliable and respected persuasion models is the Cialdini persuasion framework (“Influence, Science and Practice”, Cialdini, R. 2000, publ. Allyn & Cacon), which is based on six psychological and social principles that form the basis of corresponding persuasion strategies. These are: (1) reciprocity, (2) social proof, (3) authority, (4) commitment/consistency, (5) attraction and (6) scarcity.

Briefly, (1) relates to engendering in an individual a powerful feeling of obligating that individual to repay a favour or act that another individual has done for them; (2) relates to the behaviour of individuals being dependent on the actions of those around them, so individuals typically act as those around them are acting; (3) relates to an individual's willingness to comply with a figure or symbol of authority; (4) relates to individual's making a stand or standing by a principle or commitment and consequent reluctance or inability to back down from this; (5) relates to the way individuals are more inclined to comply with another attractive (to them) individual or someone who they know or like; and (6) relates to how individuals assign a greater worth to something that is in short supply or to short-lived opportunities.

In the present invention, the preferred persuasion strategies are based on the Cialdini persuasion framework, and therefore the strategy models stored in the model repository 10 are each preferably directed to a different one of the above persuasion strategies (1) to (6). Hence, by selecting one or more of the persuasion strategies it is possible to attempt to influence the decision of the user 7 in one or more subtly different ways, so as to determine which influences are most successful in altering the behaviour of the user 7.

However, it is to be appreciated that any suitable psychological and sociological model may be used with, and in, the interface of the present invention, so as to form the basis of one or more persuasion strategies to influence a response, behaviour or action of the user 7.

In preferred arrangements, the persuasion messages are generated by the decision testing module 8, which chooses one of the persuasion strategies for use with each persuasion message corresponding to a particular decision option. Preferably, the decision testing module 8 selects a message template from a template library and adapts a content of the message template in accordance with the chosen persuasion strategy. Preferably, the template library comprises a plurality of message templates, each including a structured content having either textual, pictorial, graphical and audio elements, or any combination thereof. The template library preferably forms part of the model repository 10 and the plurality of message templates are stored therein. Alternatively, the template library may be stored separately on a non-volatile storage means 5 associated with the processing device 2, and can be accessed by the decision testing module 8 during execution of the dialogue application 6.

In preferred arrangements, the content of the message templates is adapted by applying a natural language generation function to the template in accordance with the chosen persuasion strategy. Hence, by way of example, if the user 7 is presented with the decision point “Do you believe recycling household waste is important?”, the decision testing module 8 searches the template library to find a corresponding ‘recycling based’ message template and then applies the generation function to the message content in accordance with the selected persuasion strategy. For instance, the message template may include partly completed sentence ‘stems’ or other constructs, such as “ . . . believe recycling is important”. Hence, the generation function may then proceed to concatenate the sentence stems with corresponding sentence prefixes, stored in the template, which are specific to the particular persuasion strategy selected.

In this example, if the social proof persuasion strategy is selected, the sentence prefix could be of the form “45%-65% of UK homeowners . . . ”, or alternatively, if the authority persuasion strategy is selected the corresponding sentence prefix could be of the form “Local authorities . . . ” etc. Therefore, accompanying the decision option “Yes”, the decision testing module 8 could also present the persuasion message “45%-65% of UK homeowners believe recycling is important” or “Local authorities believe recycling is important” depending on which strategy was selected. Of course, corresponding persuasion messages would also be presented for the “No” decision option based on another one of the persuasion strategies.

It is to be appreciated that the natural language generation function may include, or act in accordance with, any suitable natural language parser and/or grammatical scheme or rule. Moreover, the generation function need not be limited to textual manipulation of message content, and instead, or additionally, may include or make use of a voice synthesiser algorithm to produce an audio ‘human-like’ voice output to the user 7 via the output device 4.

Additionally, the message templates may also include pictures or graphical elements specific to each persuasion strategy, so that the decision testing module 8 may also present a relevant picture or graphic to the user to further enhance the persuasive effect of the persuasion message. Hence, in the previous example, to accompany the social proof persuasion message, the decision testing module 8 may also cause a picture of a family recycling waste at a recycling plant to be displayed on output device 4.

Preferably, when the series of decision points are presented to the user 7 and appropriate decision options are received via the input device 3, the decision testing module 8 provides the user's selected decision options to the optimisation module 9 in the dialogue application 6. The function of the optimisation module 9 is to determine from the user's selected decision options which persuasion messages and hence persuasion strategy is most effective in influencing their responses to the decision points.

In preferred arrangements, the optimisation module 9 determines which persuasion strategy is optimum for the user 7, by determining a strength of association between the user 7 and each of the persuasion strategies. This is preferably achieved by assessing the probability of success of each strategy with the user 7 based on which decision options are selected. Any suitable statistical algorithm may be applied to the selected decision options to assess which strategy appears to be most influential to the user 7.

Preferably, the strengths of association between the user 7 and each persuasion strategy are statistically weighted by the results of the statistical algorithm. In preferred arrangements, the weights are stored in a matrix maintained by the dialogue application 6. After each user selected decision option is received the corresponding weight in the matrix is preferably updated via a modified Hebbian reinforcement rule which allows the optimisation module to ‘learn’ which associations between the user 7 and each persuasion strategy are the most strongest (or congruent). Accordingly, the strength of association having the greatest weight indicates which persuasion strategy is optimum for the user 7.

Use of a Hebbian reinforcement rule is advantageous, as such rules correspond to unsupervised learning procedures. Hence, the dialogue application 6 of the present invention is a ‘self-learning’ application which is particularly well suited for producing adaptive automated persuasion dialogues between a user 7 and the interface 1. Another advantage of Hebbian based learning is that it is relatively simple computationally, and therefore does not impose a significant burden on the processing device 2, which is particularly useful when the interface is implemented on mobile computing devices, such as PDAs and mobile phones etc.

It is to be appreciated however, that other self-learning techniques may be used with the interface 1 of the present invention, including any other suitable artificial intelligence based algorithm or neural network procedures.

In accordance with the present invention, the optimisation of the persuasion strategy is preferably an iterative process, which comprises an initial testing phase (as discussed in the foregoing arrangements) and then one or more subsequent testing or refinement phases.

Hence, refinement or further optimisation of the persuasion strategy may be achieved by presenting the user 7 with a second series of decision points, again each requiring the user 7 to select one of a plurality of possible decision options. Unlike in the initial testing phase, during the refinement phase, the decision testing module 8 will already have knowledge of which persuasion strategy is (or appears) optimum for the user 7, and therefore will provide at least one persuasion message corresponding to the optimised strategy for one of the decision options associated with each decision point. The other persuasion messages will correspond to any of the other non-optimised strategies.

The user's selected decision options will be received via the input device 3 and will be assessed by the optimisation module 9. It is to be expected that the user's selections ought to be significantly influenced by those persuasion messages corresponding to the optimum strategy. Preferably, the optimisation module 9 statistically verifies the degree of accuracy of the optimised persuasion strategy, by assessing how many times the user's decision was positively influenced by persuasion messages based on the optimum strategy. Should any statistically significant discrepancies (e.g. as assessed by conventional Ö² or maximum likelihood techniques etc.) be determined, then the weights of the strengths of association can be appropriately updated as required, so as to further optimise the persuasion strategies.

Verifying the degree of accuracy of the optimised persuasion strategy can be performed while the user 7 is providing responses to the second series of decision points, or after all the responses have been received. Alternatively, one or more refinement phases may be performed while the interface is ‘in use’ following the initial testing phase, and therefore can be done without the user 7 knowingly engaging in a second series of tests.

By ‘in use’ we mean that the user 7 and interface 1 are engaged in an automated persuasion dialogue in which the interface 1 is providing content to the user 7 which may relate to a business transaction (e.g. as in an ATM application), involve commercial activities (e.g. e-commerce) or simply conveying general advice (e.g. holiday/travel information) etc.

In other preferred arrangements, a number of modifications may be made to the interface 1, so as to further optimise persuasion strategies for users of the interface 1. Referring again to FIG. 1, there is shown a sensor array 11 associated with the processing device 2. By ‘associated’ we mean either physically connected by a hardwire link, wirelessly connected by wireless protocols (e.g. Bluetooth, WiFi), physically attached to the processing device 2 or else forming an integral part of the processing device 2. The sensor array 11 may also be attached to or form part of the computing apparatus in, or on, which the present interface 1 is implemented.

The sensor array 11 preferably contains one or more biometric sensors, including a skin chemical monitoring sensor, a heart rate monitoring sensor and a user imaging device (e.g. CCD camera). The use of biometric sensors provides additional information which may be useful in assessing which psychological and persuasive influences are useful in influencing a response, behaviour or action of the user 7. Preferably, this additional information is used in conjunction with the user's selected decision options by the optimisation module 9 in determining the optimum persuasion strategy.

It is to be appreciated that any suitable sensor or sensor type may be used in the sensor array 11 associated with the processing device 2, in accordance with the present invention.

The one or more biometric sensors are able to monitor the user's reactions to persuasive influences (e.g. as conveyed by the persuasion messages), since the chemical constituents of human perspiration, human heart rate and pupil dilation for instance can change rapidly in response to certain persuasions and persuasive stimuli. Hence, in accordance with the present invention, the dialogue application 6 is configured to receive real-time data relating to physical attributes of the user 7, which may then be used in conjunction with the user's selected decision options to determine the optimised persuasion strategy.

In preferred arrangements, the sensor data from the sensor array 11 is provided to the dialogue application 6, where it is then processed using standard algorithms (e.g. facial recognition, voice recognition etc.) as appropriate, before being provided to the optimisation module 9, where the persuasion strategies are optimised.

By ‘physical attributes’ we mean physiological and/or any underlying psychological characteristics of an individual, including, but not limited to, health indicators (such as heart rate, breathing pattern etc.), facial features (including eye movement, pupil dilation etc.), voice speech pattern (including intonation, grammar etc.), perspiration content, posture (e.g. head, shoulders) and personality type etc.

In applications where the interface 1 is implemented in, or on, a mobile computing device, such as a PDA or mobile phone etc, the mobile device may include a location tracking device, preferably a global positioning system (GPS) based transceiver, which is able to monitor the location of the user 7 and provide location data to the dialogue application 6. Having knowledge of the location of the user 7 can be advantageous, as which one of the persuasion strategies is most effective for that user 7 may vary depending on their location and environment.

Hence, for instance, the user 7 may be influenced more by messages based on the social proof persuasion strategy when in the office or when in the company of others (e.g. in a restaurant, shopping mall etc.), than when at home or alone etc. Therefore, the optimisation module 9 is configured to take into consideration the location of the user 7, when determining the optimum persuasion strategy for the user 7. In this way, the content of persuasion messages may be modified as a function of the user's location and/or adapted over time (e.g. during the working week and at weekends etc.).

Preferably, in each of the preferred arrangements, the dialogue application 6 stores which persuasion strategy is optimised for the user 7 on a non-volatile storage means 5 associated with the processing device 2. In this way, the interface 1 retains a knowledge of which influences and strategies are most effective for use with the user 7, which can then be invoked during subsequent automated persuasion dialogues between the interface 1 and that user 7.

In accordance with the present invention, the dialogue application 6 in the interface 1 may establish a connection with one or more conventional remote servers, represented generally in FIG. 1 by 12, so as to download new and updated persuasion strategy models and/or message templates etc. Preferably, the dialogue application 6 is configured to communicate either wirelessly or through a hardwired network with the server 12.

A conventional server application 13 manages the communications with the interface 1 and maintains one or more databases 14, storing the most recent versions of the strategy models and message templates for download to the interface 1.

Other embodiments are taken to be within the scope of the accompanying claims.

1. A method of operating a human-computer interface, comprising:
(a) presenting a user with a series of decision points, each decision point requiring the user to select one of a corresponding plurality of possible decision options;
(b) presenting the user with at least one persuasion message for each of the possible decision options, to persuade the user to select one of the decision options over each of the others at the time of presenting each decision point, each persuasion message being selected according to one of a plurality of different persuasion strategies;
(c) receiving the user selection of one of the possible decision options;
(d) repeating steps (a) to (c) to obtain user selected decision options for decision points based on a plurality of persuasion strategies to determine a persuasion strategy that is optimised for the user; and
(e) subsequently delivering persuasion messages to the user based on the optimised persuasion strategy.

2. The method of claim 1, in which step (d) is followed by a test or refinement phase, comprising the steps of:
(i) presenting the user with a second series of decision points, each decision point requiring the user to select one of a plurality of possible decision options;
(ii) presenting the user with at least one persuasion message corresponding to each one of the possible options, in which the persuasion message for one option is selected according to the optimised persuasion strategy and the persuasion message for another option is selected according to a non-optimised persuasion strategy;
(iii) receiving the user selection of one of the possible decision options;
(iv) repeating steps (i) to (iii) to determine a degree of accuracy of the optimised persuasion strategy; and
(v) adapting the optimised persuasion strategy

3. The method of claim 2 in which the steps (i) to (v) are performed during, or interspersed with, persuasion messages delivered in step (e).

4. The method of claim 1, further comprising generating the at least one persuasion message by:
choosing one of the plurality of different persuasion strategies;
adapting a content of a message template in accordance with the chosen persuasion strategy.

5. The method of claim 1, further comprising generating the at least one persuasion message by applying a natural language generation function to a message template to adapt a content of the template in accordance with one of the plurality of different persuasion strategies.

6. The method of claim 1, wherein determining an optimised persuasion strategy includes:
determining a strength of association between the user and each of the plurality of persuasion strategies; and
weighting the strengths of association based on the selected decision options, such that the association having the greatest weight indicates which persuasion strategy is optimum for the user.

7. The method of claim 6, wherein determining a strength of association includes assessing the probability of success of each of the plurality of persuasion strategies with the user.

8. The method of claim 6, wherein determining the optimised persuasion strategy further includes:
updating the weights of the strengths of association after each selected decision option is received from the user.

9. The method of claim 8, wherein the updating is based on a Hebbian reinforcement rule.

10. The method of claim 1, further comprising:
receiving real-time data relating to physical attributes of the user; and
using the data relating to the physical attributes in conjunction with the user selected decision options in determining a persuasion strategy that is optimised for the user.

11. The method of claim 1, further comprising:
detecting a location of the interface; and
modifying a content of a persuasion message as a function of the detected location.

12. The method of claim 1, wherein presenting and/or delivering the persuasion messages includes presenting the messages in one or more of the following formats: textual, pictorial, graphical and audio.

13. The method of claim 1, wherein the plurality of different persuasion strategies is based on a Cialdini persuasion framework.

14. A human-computer interface for adaptive persuasion dialogue, comprising:
(a) means for presenting a user with a series of decision points, each decision point requiring the user to select one of a plurality of possible decision options;
(b) means for presenting the user with at least one persuasion message for each of the possible decision options to persuade the user to select one of the decision options over each of the others at the time of presenting each decision point, each persuasion message being selected according to one of a plurality of different persuasion strategies;
(c) means for receiving the user selection of one of the possible decision options;
(d) means for determining a persuasion strategy that is optimised for the user by repeating the presenting and receiving steps in (a) to (c) to obtain user selected decision options for decision points based on a plurality of persuasion strategies; and
(e) means for subsequently delivering persuasion messages to the user based on the optimised persuasion strategy.

15. The interface of claim 14, wherein the interface includes a test or refinement phase which follows the step of determining an optimised persuasion strategy, the interface further comprising:
(i) means for presenting the user with a second series of decision points, each decision point requiring the user to select one of a plurality of possible decision options;
(ii) means for presenting the user with at least one persuasion message corresponding to each one of the possible options, in which the persuasion message for one option is selected according to the optimised persuasion strategy and the persuasion message for another option is selected according to a non-optimised persuasion strategy;
(iii) means for receiving the user selection of one of the possible decision options;
(iv) means for determining a degree of accuracy of the optimised persuasion strategy by repeating the presenting and receiving steps of (i) to (iii); and
(v) means for adapting the optimised persuasion strategy.

16. The interface of claim 14, further comprising one or more biometric sensors for determining physical attributes of the user.

17. The interface of claim 14, further comprising means for detecting a location of the interface.
